(19) United States
(12) Patent Application Publication
(10) Pub. No.: US 2012/0188924 A1
(43) Pub. Date: Jul. 26, 2012

(54) METHOD FOR CONTROLLING POWER IN WIRELESS AD-HOC NETWORK

(75) Inventors: Choongil Yeh, Daejeon (KR); Dong Hyun Ahn, Daejeon (KR)

(73) Assignee: Electronics and Telecommunications Research Institute, Daejeon (KR)

(21) Appl. No.: 13/268,575

(22) Filed: Oct. 7, 2011

(30) Foreign Application Priority Data
Jan. 26, 2011 (KR) 10-2011-0007856

(51) Int. Cl. H04W 52/04

(52) U.S. Cl. 370/311

(57) ABSTRACT

A node in a wireless network system determines transmission power by performing transmission power control only on a plurality of data subcarriers, other than a plurality of pilot subcarriers, of a PDU slot or ACK slot to be transmitted, and then transmits the data subcarriers of the PDU slot or ACK slot at the determined transmission power and transmits the pilot subcarriers of the PDU slot or ACK slot at a fixed power level. Accordingly, neighboring nodes determine whether or not a channel of the PDU slot or ACK slot is sensed by using the pilot subcarriers of the PDU slot or ACK slot.

### CROSS-REFERENCE TO RELATED APPLICATION

This application claims priority to and the benefit of Korean Patent Application No. 10-2011-0007856 filed in the Korean Intellectual Property Office on Jan. 26, 2011, the entire contents of which are incorporated herein by reference.

### BACKGROUND OF THE INVENTION

(a) Field of the Invention

The present invention relates to a method for controlling power in a wireless ad-hoc network. More particularly, the present invention relates to power control in a wireless network where a channel is shared between neighboring nodes.

(b) Description of the Related Art

Power control is required to save power and increase network capacity in a wireless ad-hoc network or wireless packet network.

Ongoing studies on power control are being conducted to gain the following two advantages. The first is to extend the operating lifetimes of nodes operating on batteries, etc. by reducing power consumption by using minimum transmission power for maintaining Quality of Service (QoS) requirements. The second is to maximize network capacity and improve spectrum usage efficiency by reducing interference between communication channels using the same frequency resource by using minimum transmission power for maintaining Quality of Service (QoS) requirements.

The multiple access protocol most widely used in the IEEE 802.11 standard is a Carrier Sense Multiple Access with Collision Avoidance (CSMA/CA), and no power control is used in the CSMA/CA protocol.

In general, a wireless ad-hoc or wireless packet network based on the IEEE 802.11 standard is based on the CSMA/CA protocol, and each node accesses a channel, which is a shared resource, using the CSMA/CA protocol to get permission to use the channel. Accordingly, in the wireless ad-hoc or wireless packet network based on the IEEE 802.11 standard, nodes transmit packets at an agreed, fixed power level without any power control.

More specifically, a node using the CSMA/CA protocol firstly senses a shared channel before packet transmission in order to determine whether or not the shared channel is occupied by another node. If the shared channel is not occupied by another node, the node determines that the channel is available. At this point, when the node using the CSMA/CA protocol transmits packets at low power under power control so as to reduce power consumption and reduce interference between channels using the same frequency, neighboring nodes may determine that the corresponding channel is available even when the corresponding channel is occupied. In this case, the neighboring nodes attempt to occupy the corresponding channel, and as a result, the neighboring nodes simultaneously start packet transmission using the corresponding channel. This leads to a collision, and therefore the receiving node cannot successfully receive the packets. That is, if nodes perform power control without appropriate follow-up, the neighboring nodes fail to sense a channel in which packets are transmitted at low power, and this phenomenon cause a packet collision and degrades the overall throughput. As a result, network performance will be degraded. Therefore, no power control is used in a wireless ad-hoc or wireless packet network based on the IEEE 802.11 standard.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a power control apparatus and method, which prevent a neighboring node from failing to sense the occupation of a channel as a node performs power control in a wireless network.

An exemplary embodiment of the present invention provides a method for a node to control power in a wireless ad-hoc network using a frame structure where a plurality of slots are multiplexed within one radio frequency band. The power control method includes: sensing whether or not slots multiplexed in a frame are occupied by other nodes and currently used for transmission; and performing transmission power control on data subcarriers, other than pilot subcarriers, of a slot to be transmitted, among non-occupied slots.

The sensing comprises may include: measuring electromagnetic power using at least one subcarrier of a slot to be sensed among the plurality of slots; and determining, from the electromagnetic power, whether or not the slot is occupied.

The determining may include: if the electromagnetic power is more than a set reference value, identifying the slot as occupied; and if the electromagnetic power is less than the reference value, identifying the slot as not occupied.

The power control method may further include transmitting the data subcarriers of the slot to be transmitted at a controlled transmission power and transmitting the pilot subcarriers at a fixed power level. The measuring may include measuring electromagnetic power using the pilot subcarriers transmitted at a fixed power level in the slot to be sensed.

Furthermore, the power control method may further include: transmitting all the subcarriers of the slot to be transmitted under transmission power control; and generating a carrier sensing slot that a neighboring node uses to sense whether a slot is occupied or not by using designated subcarriers, other than the subcarriers of the slot to be transmitted, and simultaneously transmitting the carrier sensing slot and the slot to be transmitted.

The transmitting of the carrier sensing slot may include transmitting the carrier sensing slot at a fixed power level.

Another exemplary embodiment of the present invention provides a method for a node to control power in a wireless ad-hoc network using a frame where a plurality of packet data unit (PDU) slots and a plurality of acknowledgment (ACK) slots are multiplexed. The frame further includes: a plurality of PDU sensing slots respectively corresponding to the plurality of PDU slots and used to sense whether channels of the plurality of PDU slots are occupied or not; and a plurality of ACK slots respectively corresponding to the plurality of ACK slots and used to sense whether channels of the plurality of ACK slots are occupied or not, and the power control method includes: performing power control on all subcarriers of non-occupied PDU slots or non-occupied ACK slots; and transmitting all subcarriers of the PDU sensing slots or ACK sensing slots respectively corresponding to the non-occupied PDU slot or ACK slots corresponding to the non-occupied PDU slots or non-occupied ACK slots at a fixed power level.

The power control method further includes sensing whether or not the PDU slots or ACK slots are occupied by other nodes and currently used for transmission.

The sensing may include: measuring electromagnetic power using at least one subcarrier of each PDU sensing slot or each ACK sensing slot; and determining, from the electromagnetic power, whether or not the PDU slots or ACK slots are occupied.

### BRIEF DESCRIPTION OF THE DRAWINGS

FIG. 1 is a view showing a wireless network to which an exemplary embodiment of the present invention is applied.

FIG. 2 is a view showing a frame structure according to a first exemplary embodiment of the present invention.

FIG. 3 is a view showing a tile structure for configuring slots in a frame according to an exemplary embodiment of the present invention.

FIG. 4 is a view showing an example of a slot configuration method according to an exemplary embodiment of the present invention.

FIG. 5 is a flowchart showing a carrier sensing method according to an exemplary embodiment of the present invention.

FIGS. 6 and 7 are views showing power control methods according to the first and second exemplary embodiments of the present invention.

FIGS. 8 and 9 are views showing an example of a frame according to the second exemplary embodiment of the present invention.

FIG. 10 is a view showing a power control apparatus according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification and claims, unless explicitly described to the contrary, the word “comprise” and variations such as “comprises” or “comprising”, will be understood to imply the inclusion of stated elements but not the exclusion of any other elements.

Now, an apparatus and method for controlling power in a wireless ad-hoc network according to an exemplary embodiment of the present invention will be described in detail with reference to the drawings.

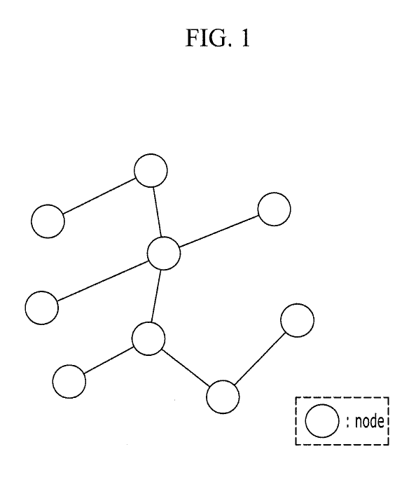

FIG. 1 is a view showing a wireless network to which an exemplary embodiment of the present invention is applied.

FIG. 1 illustrates an ad-hoc network as the wireless network to which the exemplary embodiment of the present invention, in which a plurality of nodes communicate in a multi-hop fashion.

Referring to FIG. 1, the ad-hoc network may include a plurality of nodes.

The nodes refer to devices, each of which shares and manages the same wireless communication resources as those of neighboring nodes without a coordinator for managing wireless communication resources shared by the neighboring nodes.

These nodes can transmit packets at low power under power control.

Such an ad-hoc network is a network having no fixed gateway, in which all the nodes are mobile and can be dynamically connected.

The ad-hoc network may be a wireless ad-hoc network based on the IEEE 802.11 standard. A radio frequency (RF) channel in the wireless ad-hoc network based on the IEEE 802.11 standard refers to a channel.

Moreover, the ad-hoc network may be an OFDM (Orthogonal Frequency Division Multiplexing)-based ad-hoc network. Further, the ad-hoc network may be an OFDMA (Orthogonal Frequency Division Multiple Access)-based ad-hoc network where subcarriers in OFDM are shared and used by a plurality of nodes.

An RF channel in the OFDMA-based ad-hoc network refers to a plurality of channels.

In what follows, the exemplary embodiment of the present invention will be described assuming that the wireless network is an OFDMA-based multi-channel wireless ad-hoc network.

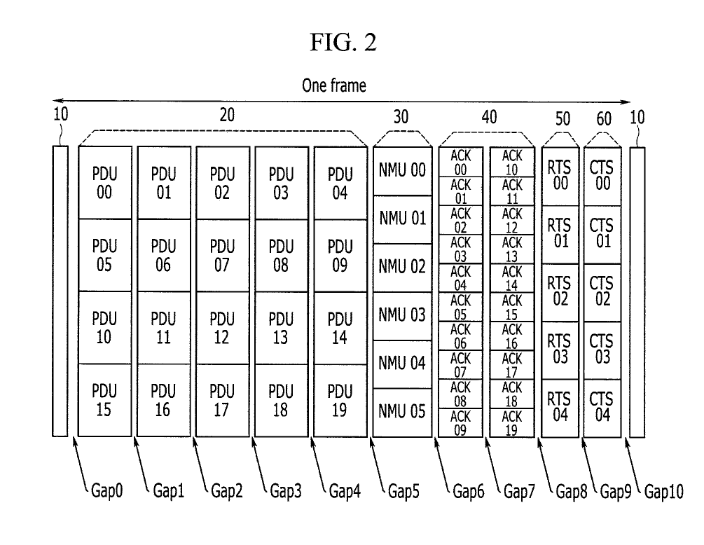

FIG. 2 is a view showing a frame structure according to a first exemplary embodiment of the present invention.

Nodes in the multi channel wireless ad-hoc network can communicate using the frame shown in FIG. 2.

Referring to FIG. 2, the frame according to an exemplary embodiment of the present invention comprises a preamble 10, a packet data unit (PDU) slot area 20, a maintenance unit (NMU) slot area 30, an acknowledgment (ACK) slot area 40, a request-to-send (RTS) slot area 50, and a clear-to-send (CTS) slot area 60.

The PDU slot area 20 comprises a plurality of PDU slots PDU00 to PDU19.

The NMU slot area 30 comprises a plurality of NMU slots NMU00 to NMU05.

The ACK slot area 40 comprises the same number of ACK slots ACK00 to ACK19 as the PSU slots. The PDU slots PDU00 to PDU19 are paired with the ACK slots ACK00 to ACK19 on a one-to-one basis.

The RTS slot area 50 comprises a plurality of RTS slots RTS00 to RTS04.

The CTS slot area 60 comprises the same number of CTS slots CTS00 to CTS04 as the RTS slots. The RTS slots RTS00 to RTS04 are paired with the CTS slots CTS00 to CTS04 on a one-to-one basis.

The preamble 10 is placed at the beginning of the frame, then the PDU slots PDU00 to PDU19 are placed, and then the NMU slots NMU00 to NMU05 are placed. Also, the ACK slots ACK00 to ACK19 are placed subsequent to the NMU slots NMU00 to NMU05. The RTS slots RTS00 to RTS04 are placed next to the ACK slots ACK00 to ACK19, and finally the CTS slots CTS00 to CTS04 are placed. Subsequently, the next frame begins.

Gaps Gap0 to Gap10 are defined between the slots, where there is no transmission made in consideration of RF switching time and time required for decoding. The gaps Gap0 to Gap10 represent segments where transmission is not allowed in consideration of switching between transmission and reception and time required for decoding.

The preamble 10 is a preamble signal used for synchronizing relay.

The PDU slots PDU00 to PDU19 are slots or channels used to transmit user data, and the NMU slots NMU00 to NMU05 represent slots or channels broadcast to neighboring nodes for the purpose of routing, synchronizing relaying, etc. The ACK slots ACK00 to ACK19 are slots or channels used to report the success/failure of reception of a corresponding PDU, the RTS slots RTS00 to RTS04 are slots or channels used to send an occupation request of the PDU slot, and the CTS slots CTS00 to CTS04 are slots or channels used to accept the occupation request of the PDU slot.

The vertical axis of the frame represents the order of subcarriers, and the horizontal axis thereof represents the order of OFDMA symbols. The nodes can send and receive individual messages using each slot because the slots serve as individual communication channels, and the individual nodes can simultaneously process a plurality of slots in view of the characteristics of OFDMA. This makes it easier for the frame having the structure as shown in the exemplary embodiment of the present invention to support the configuration of a multi-channel wireless ad-hoc network supporting multi-channel random multiple access and multi-hop connection.

Although the exemplary embodiment of the present invention illustrates that the number of PDU slots PDU00 to PDU19 and the number of ACK slots ACK00 to ACK19 are 20 each, the number of NMU slots NMU00 to NMU05 is 6, and the number of RTS slots RTS00 to RTS04 and the number of CTS slots CTS00 to CTS04 are 5 each, the present invention is not limited thereto. Moreover, the frame according to the exemplary embodiment of the present invention is not limited to the structure as shown in FIG. 2, and, for example, OFDM and single carrier frame structures can be used.

For example, when “xx” (x=0, 1, 2, 3, . . . ,) numbers are assigned to the slots as shown in FIG. 2, PDUxx is paired with ACKxx. Thus, a node designated to receive PDUxx necessarily has to notify a node designated to send PDUxx of the success or failure of decoding of data received in PDUxx by using the ACKxx slot. For example, PUD 00 is paired with ACK 00, and a node designated to receive PDU 00 notifies a node that has sent PDU 00 of ACK of data received in PDU 00 by using ACK 00.

In such a wireless environment, the first thing the node that has achieved common time synchronization has to do is to measure whether a PDU slot and an ACK slot are occupied or not. When both a PDU slot (PDUxx) and an ACK slot (ACKxx) are not occupied by other nodes, a node wanting to start communication may send a message requesting to send data to other nodes in a PDU slot (PDUxx) by using an RTS slot.

Also, when the PDU slot (PDUxx) is occupied by another node and the ACK slot (ACKxx) is not occupied, a node wanting to start communication may start a procedure to get permission to use the PDU slot (PDUxx) by using the RTS slot. In this case, the problem of exposed nodes in WLANs (Wireless Local Area Networks) can be perfectly solved.

Moreover, when both the PDU slot (PDUxx) and the ACK slot (ACKxx) paired with the PDU slot (PDUxx) are occupied by other nodes, and when the PDU slot (PDUxx) is not occupied but the ACK slot (ACKxx) is occupied by another node, if it is determined that no request to get permission to use the PDU slot (PDUxx) is made through the RTS slot, the problem of hidden nodes in WLAN also can be perfectly solved.

The CTS slots CTS00 to CTS04 are slots used in the procedure in which a node that has received a request for permission to use a PDU slot in an RTS slot gives permission to use the PDU slot. The nodes use the RTS slots RTS00 to RTS04 and the CTS slots CTS00 to CTS04 for the purpose of reserving PDU/ACK slots through a random access process, and the reserved PDU/ACK slots can be used continuously.

The NMU slots NMU00 to NMU05 can be used for the purpose of routing path setup, synchronous transmission, and so on. The nodes can transmit information of neighboring nodes and information required for a protocol supporting synchronous transmission by using the NMU slots NMU00 to NMU05. All the nodes transmit at least one of the NMU slots NMU00 to NMU05 at a random timing every predetermined time (t seconds). For example, assuming that the length of a frame is 10 msec (t=5 sec), all the nodes each select one NMU slot in a random manner every 500 frames, and transmit required information using the selected NMU slot. Even in the event of collision due to random transmission of NMU slots, the nodes continue to transmit the NMU slots at a random timing every t seconds regardless of the collision. The information transmitted by the NMU slots change over time to become adapted to environment changes caused by the movement of a terminal.

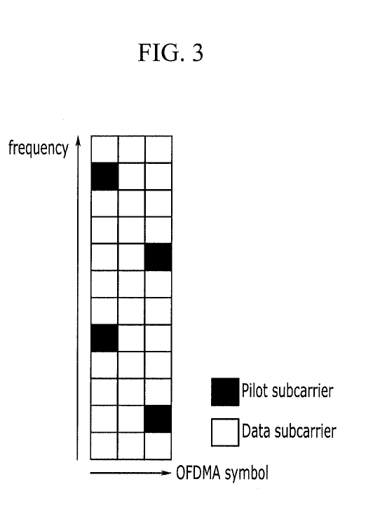

FIG. 3 is a view showing a tile structure for configuring slots in a frame according to an exemplary embodiment of the present invention.

Each slot is the smallest unit of data transmission, and may be referred to as a channel. A slot consists of tiles uniformly distributed throughout the whole frequency band to achieve frequency diversity.

Referring to FIG. 3, the tiles for the RTS slots RTS00 to RTS04 and the CTS slots CTS00 to CTS04 comprise a plurality of, e.g., Nsub adjacent subcarriers and a plurality of, e.g., Nsys adjacent OFDMA symbols. In this case, the tiles include Nsub*Nsys subcarriers, and some of the Nsub*Nsys subcarriers are pilot subcarriers used for channel estimation and required channel measurement and the rest of them are data subcarriers used for data transmission.

The RTS slots RTS00 to RTS04 and the CTS slots CTS00 to CTS04 may have the same tile structure or different tile structures.

FIG. 3 assumes that Nsub=12 and Nsys=3, but the present invention is not limited thereto.

Moreover, other slots than the RTS slots RTS00 to RTS04 and the CTS slots CTS00 to CTS04, for example, the PDU slots PDU00 to PDU19, the ACK slots ACK00 to ACK19, and the NMU slots NMU00 to NMU05 may comprise tiles having the same structure as above.

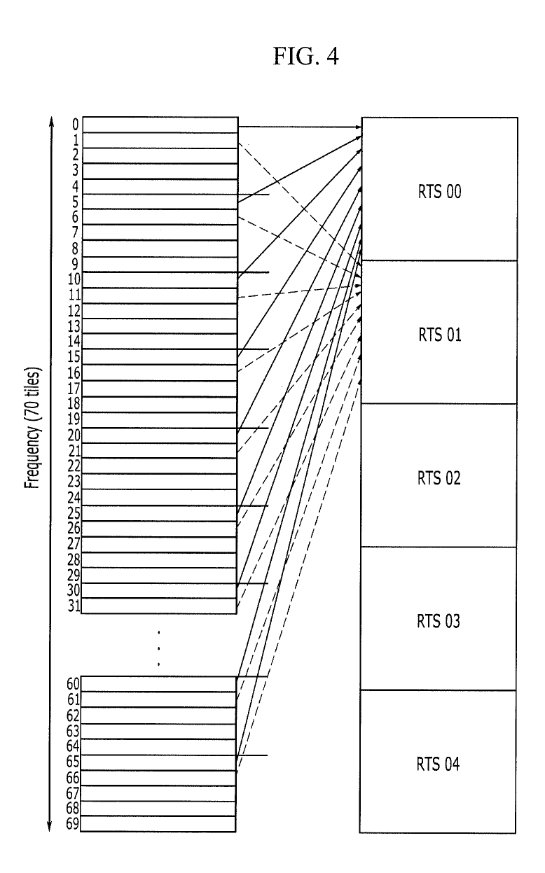

FIG. 4 is a view showing an example of a slot configuration method according to an exemplary embodiment of the present invention.

FIG. 4 illustrates a method of configuring the RTS slots RTS00 to RTS04 as an example of the slot configuration method.

Referring to FIG. 4, the entire frequency band in the RTS region (50 of FIG. 2) of a frame comprises 70 tiles, and, assuming that there are five RTS slots RTS00 to RTS04 altogether in the RTS area, each of the RTS slots RTS00 to RTS04 may comprise 14 tiles. Moreover, one is selected from every 5 tiles so that 14 files for configuring one RTS slot are uniformly distributed throughout the entire frequency band.

As such, subcarriers constituting all the RTS slots RTS00 to RTS04 are uniformly distributed throughout the entire frequency band, thus achieving frequency diversity.

Based on this principle, the CTS slots CTS00 to CTS04, the PDU slots PDU00 to PDU19, the ACK slots ACK00 to ACK19, and the NMU slots NMU00 to NMU05 can be configured.

Now, the problems to be solved by the present invention will be described. The media access control (MAC) protocols widely used to avoid collisions and improve throughput when a plurality of nodes share a common channel include carrier sense multiple access (CSMA) and carrier sense multiple access with collision avoidance (CSMA/CA). The CSMA protocol detects a channel occupation state using an actual physical method, and the CSMA/CA protocol employs a hand-shaking protocol using RTS/CTS slots, as well as physical detection of channel occupation. The handshaking protocol using RTS/CTS slots is a protocol that was intended to prevent degradation of network capacity caused by the hidden node problem that occurs in a CSMA-based wireless ad-hoc network.

In the frame structure shown in FIG. 2, carrier sensing is performed simultaneously on the PDU slots PDU00 to PDU19 and the ACK slots ACK00 to ACK19. Accordingly, the exposed-node and hidden-node problems can be resolved.

In the frame structure according to an exemplary embodiment of the present invention, it is necessary for a node to perform two-way handshaking using RTS/CTS slots. The two-way handshaking using RTS/CTS slots must be performed after sensing a carrier in order to reserve PDU slots and transmit packets in the reserved PDU slots.

Using the frame structure according to an exemplary embodiment of the present invention, the carrier sensing and handshaking procedure can be completed within one frame, thus enabling it to provide a fast communication connection service, and a node can transmit packets in reserved PDU slots at the next frame immediately after the completion of the above procedure.

Next, a carrier sensing method according to an exemplary embodiment of the present invention will be described.

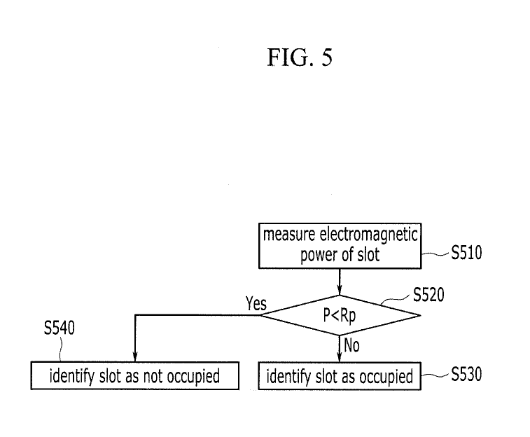

FIG. 5 is a flowchart showing a carrier sensing method according to an exemplary embodiment of the present invention.

In the OFDMA, a plurality of channels, i.e., slots, in one RF channel have to be distinguished. Thus, a node performs carrier sensing after a fast Fourier transform (FFT) step.

Referring to FIG. 5, a node measures electromagnetic power received from each slot (S510). The electromagnetic power can be measured by Equation 1:

$$P = \frac{1}{N} {\sum }_{i = 0}^{N - 1} ( {I}_{i}^{2} + {Q}_{i}^{2} ) \qquad [ Equation 1 ]$$

where N is the number of subcarriers used for power measurement in a given slot, i is an identifier for dividing subcarriers used for power measurement, Iᵢ is an in-phase component of the i-th subcarrier output of FFT, and Qᵢ is a quadrature-phase component of the i-th subcarrier output of FFT.

The node compares the electromagnetic power P of each slot with a set reference value Rp (S520).

If the electromagnetic power P is more than the set reference value Rp, the node considers that the corresponding slot is occupied and used by another node (S530).

In contrast, if the electromagnetic power P is less than the set reference value Rp, the node identifies the corresponding slot as not occupied by other nodes (S540).

In Equation 1, the node can measure electromagnetic power by using some of the subcarriers of the corresponding slot.

As in the aforementioned slot configuration method, the node is able to find out which subcarriers of each slot are pilot subcarriers and which subcarriers are data subcarriers.

According to an exemplary embodiment of the present invention, the pilot subcarriers among the subcarriers of the corresponding slot are used to measure electromagnetic power. At this point, the pilot subcarriers among the subcarriers of the slot are transmitted at a fixed power level without any power control, and the data subcarriers are transmitted under power control. Such electromagnetic power measurement may be of particular significance.

When power control is performed on PDU slots and ACK slots, a slot transmitted at low power is recognized as a channel not occupied by neighboring nodes, thus causing a collision. As a result, throughput may be degraded. As a method for preventing network performance degradation caused by throughput degradation, no power control is performed on the pilot subcarriers while power control is performed only on the data subcarriers. Accordingly, performance degradation caused by collision can be prevented, and a throughput increase can be obtained through the use of power control. Moreover, by transmitting the pilot subcarriers at a set fixed power level, the neighboring nodes can be notified whether a channel is occupied or not, and channel estimation errors can be greatly reduced.

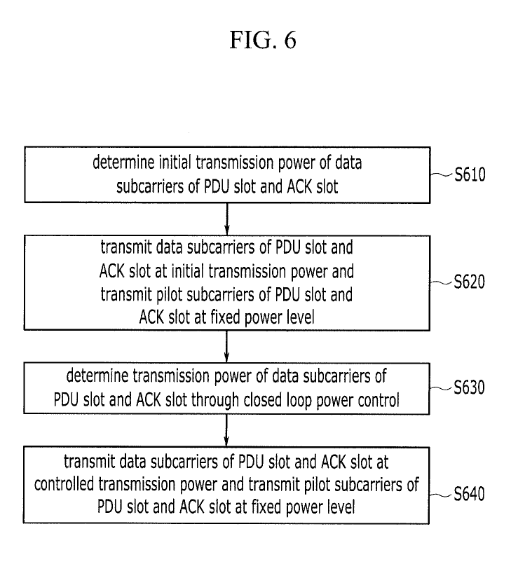

Such a power control method will be described in detail with reference to FIGS. 6 to 9.

FIG. 6 is a view showing a power control method according to the first exemplary embodiment of the present invention.

In the frame structure of FIG. 2, a node according to the exemplary embodiment of the present invention transmits the preamble 10, the NMU slots NMU00 to NMU05, the RTS slots RTS00 to RTS04, and the CTS slots CTS00 to CTS04 at a fixed power level without any power control, and performs closed loop power control on the PDU slots PDU00 to PDU19 and the ACK slots ACK00 to ACK19.

The node performs no power control on the pilot subcarriers, among the subcarriers of the PDU slots PDU00 to PDU19 and ACK slots ACK00 to ACK19, while performing power control only on the data subcarriers.

Referring to FIG. 5, regarding the power control, the node senses whether or not a plurality of slots present in a radio frequency band are occupied and used for transmission by other neighboring nodes.

If the node wants to use at least one of the PDU slots or ACK slots not occupied and used for transmission by other neighboring nodes, the node firstly reserves one PDU slot or ACK slot by a handshaking procedure using RTS/CTS slots. Therefore, the initial transmission power of a PDU slot and an ACK slot paired with the PDU slot are determined based on the Carrier to Interference and Noise Ratio (CINR) of a received CTS slot and a received RTS slot.

The node can determine the initial transmission power applied to the data subcarriers of the PDU slot and ACK slot based on Equations 2 and 3 (S610).

P_{PDU,init}(dBₘ)=min(CINR_{PDU,req}+(P_{CTS}−CINR_{CTS,meas})+Offset,Pₘₐₓ) [Equation 2]

P_{ACK,init}(dBₘ)=min(CINR_{ACK,req}+(P_{RTS}−CINR_{RTS,meas})+Offset,Pₘₐₓ) [Equation 3]

where P_{PDU,init} represents the initial transmission power of the data subcarriers of the PDU slot, and P_{ACK,init} represents the initial transmission power of the data subcarriers of the ACK slot. CINR_{PDU,req} represents the required CINR of the PDU slot, and CINR_{ACK,req} represents the required CINR of the ACK slot. P_{CTS} represents the fixed transmission power of the CTS slot, and P_{RTS} represents the fixed transmission power of the RTS slot. Also, CINR_{CTS,mean} represents the CINR measured for the received CTS slot, and CINR_{RTS,mean} represents the CINR measured for the received RTS slot. Offset represents the power required to give a margin, and Pₘₐₓ represents maximum transmission power. min(A,B) are the smallest of A and B.

Once the initial transmission power is thusly determined, the node transmits the data subcarriers of the PDU slot and ACK slot at the initial transmission power, and transmits the pilot subcarriers of the PDU slot and ACK slot at a fixed power level (S620).

The node determines transmission power by Equations 4 and 5 by performing closed loop power control on the data subcarriers of the PDU slot and ACK slot to be transmitted starting from the next frame (S630).

P_{PDU,k}(dBₘ)=min(P_{PDU,k-1}+ΔP_{PDU,k},Pₘₐₓ) [Equation 4]

P_{ACK,k}(dBₘ)=min(P_{ACK,k-1}+ΔP_{ACK,k},Pₘₐₓ) [Equation 5]

where P_{PDU,k} represents the transmission power of the k-th PDU slot, and P_{ACK,k} represents the transmission power of the k-th ACK slot. ΔP_{PDU,k} represents power increase or decrease which is reported by the node having received the PDU slot with reference to the CINR measured for the previous (k−1)-th PDU slot when sending the ACK slot, and ΔP_{ACK,k} represents power increase or decrease which is reported by the node having received the ACK slot with reference to the CINR measured for the previous (k−1)-th ACK slot when sending the PDU slot.

Once the transmission power is determined based on Equations 4 and 5, the node transmits the data subcarriers of the PDU slot and ACK slot at the transmission power determined in the corresponding frame, and transmits the pilot subcarriers of the PDU slot and ACK slot at a fixed power level (S640).

In this manner, neighboring nodes can determine whether or not the corresponding PDU slot and ACK slot are occupied by using the pilot subcarriers of the PDU slot and ACK slot by Equation 1.

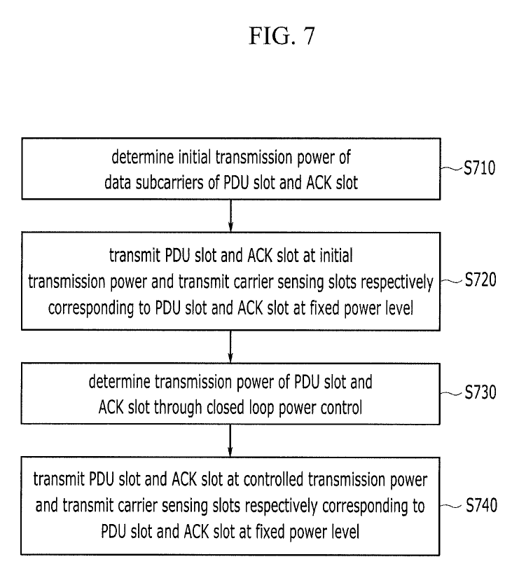

FIG. 7 is a power control method according to a second exemplary embodiment of the present invention.

The power control method according to the second exemplary embodiment of the present invention can be applied to the case where carrier sensing slots respectively corresponding to a PDU slot and an ACK slot are present within a frame.

Referring to FIG. 7, a node determines the initial transmission power of the PDU slot and ACK slot based on the above-described Equations 2 and 3 (S710).

Once the initial transmission power is determined, the node transmits the PDU slot and the ACK slot at the initial transmission power, and transmits the carrier sensing slots respectively corresponding to the PDU slot and the ACK slot at a fixed power level (S720). In this way, when the carrier sensing slots are provided, the power control of the PDU slot and the ACK slot are performed on both of the pilot and data subcarriers.

The node determines transmission power by the above-described Equations 4 and 5 by performing closed loop power control on the PDU slot and ACK slot to be transmitted, starting from the next frame (S730).

The node transmits the PDU slot and the ACK slot at transmission power, and transmits the carrier sensing slots respectively corresponding to the PDU slot and the ACK slot at a fixed power level (S740).

For example, the node transmits packets in a PDU slot (PDUxx) at the transmission power determined based on the above-described method, and at the same time transmits the carrier sensing slot corresponding to the PDU slot (PDUxx) at a fixed power level.

In this manner, neighboring nodes can determine whether or not the corresponding PDU slot and ACK slot are occupied by using the carrier sensing slots by Equation 1.

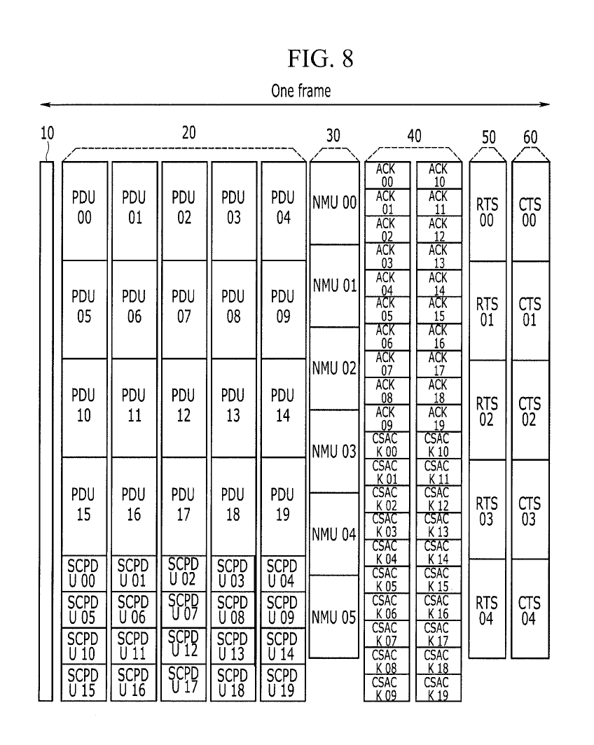

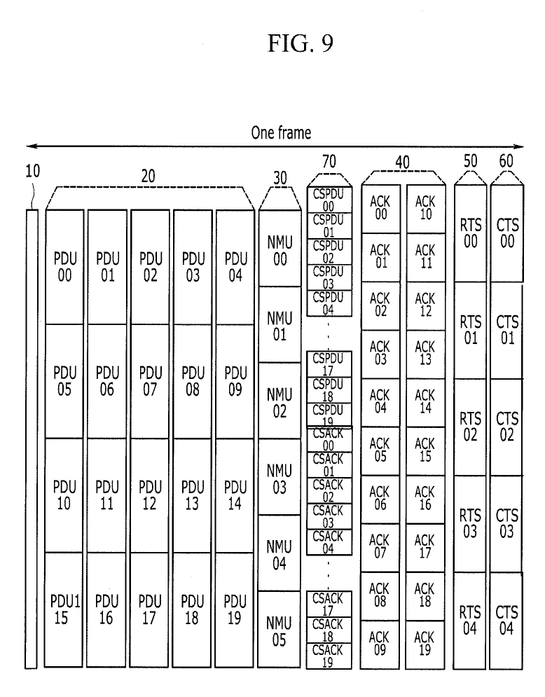

FIGS. 8 and 9 are views showing an example of a frame according to the second exemplary embodiment of the present invention.

Referring to FIGS. 8 and 9, the frame may further comprise carrier sensing slots CSPDU00 to CSPDU19 respectively corresponding to the PDU slots PDU00 to PDU19 and carrier sensing slots CSACK00 to CSACK19 respectively corresponding to the ACK slots ACK00 to ACK 19.

The carrier sensing slots CSPDU00 to CSPDU19 and CSACK00 to CSACK19 are slots or channels used to determine whether or not the corresponding slots are occupied.

If the number of PDU slots in the frame is N, the number of ACK slots is N. At this point, N carrier sensing slots respectively corresponding to the PDU slots and N carrier sensing slots respectively corresponding to the ACK slots are included within the frame by using subcarriers other than the subcarriers of the PDU slot and ACK slot.

The carrier sensing slots CSPDU00 to CSPDU19 respectively corresponding to the PDU slots PDU00 to PDU19 may be included in the area where the corresponding PDU slots PDU00 to PDU19 are located, and the carrier sensing slots ACK00 to ACK19 respectively corresponding to the ACK slots ACK00 to ACK19 may be included in the area where the corresponding ACK slots CSACK00 to CSACK19 are located.

On the other hand, the frame may comprise a carrier sensing slot area 70 as shown in FIG. 9.

The carrier sensing slot area 70 comprises carrier sensing slots CSPDU00 to CSPDU19 and CSACK00 to CSACK19. That is, unlike FIG. 8, the carrier sensing slots CSPDU00 to CSPDU19 and CSACK00 to CSACK19 are located at different positions from the PDU slot area 20 and the ACK slot area 40.

A node transmitting a PDU slot always transmits a carrier sensing slot corresponding to the PDU slot at a fixed power level, and a node transmitting an ACK slot always transmits a carrier sensing slot corresponding to the ACK slot at a fixed power level.

In this manner, gain is achieved from power control without degrading the carrier sensing performance of neighboring nodes caused by the power control.

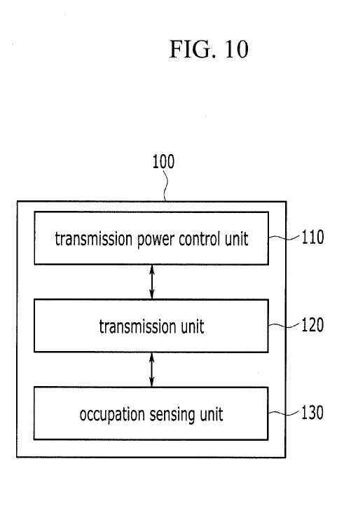

FIG. 10 is a view showing a power control apparatus according to an exemplary embodiment of the present invention.

Referring to FIG. 10, a node comprises a power control apparatus 100.

The power control apparatus 100 comprises a transmission power control unit 110, a transmission unit 120, and an occupation sensing unit 130.

The transmission power controller 110 determines the transmission power of a PDU slot and an ACK slot based on the above-explained Equations 2 to 4. However, for the frame as shown in FIG. 2, the transmission power control unit 110 performs power control only on data subcarriers among the subcarriers of the PDU slot and ACK slot.

The transmission unit 120 transmits the corresponding PDU slot and ACK slot at the transmission power determined by the transmission power control unit 110.

For the frame as shown in FIG. 2, the transmission unit 120 transmits data subcarriers among the subcarriers of the PDU slot and ACK slot at the transmission power determined by the transmission power control unit 110, and transmits pilot subcarriers among the subcarriers of the PDU slot and ACK slot at a set fixed power level.

For the frame as shown in FIGS. 8 and 9, the transmission unit 120 transmits the subcarriers of the PDU slot and ACK slot at the transmission power determined by the transmission power control unit 110, and transmits a carrier sensing slot corresponding to the PDU slot and a carrier sensing slot corresponding to the ACK slot at a fixed power level.

According to the exemplary embodiments of the present invention, gain can be achieved from power control since the power control is done in such a manner not to affect a neighboring node's sensing the occupation of a channel even if the power control is used in a wireless network.

The exemplary embodiments of the present invention described above are not only implemented by the method and apparatus, but it may be implemented by a program for executing the functions corresponding to the configuration of the exemplary embodiment of the present invention or a recording medium having the program recorded thereon. These implementations can be realized by the ordinary skilled person in the art from the description of the above-described exemplary embodiments.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for a node to control power in a wireless ad-hoc network using a frame structure where a plurality of slots are multiplexed within one radio frequency band, the method comprising:
sensing whether or not slots multiplexed in a frame are occupied by other nodes and currently used for transmission; and
performing transmission power control on data subcarriers, other than pilot subcarriers, of a slot to be transmitted, among non-occupied slots.

2. The method of claim 1, wherein the sensing comprises:
measuring electromagnetic power using at least one subcarrier of a slot to be sensed among the plurality of slots; and
determining, from the electromagnetic power, whether or not the slot is occupied.

3. The method of claim 2, wherein the determining comprises:
if the electromagnetic power is more than a set reference value, identifying the slot as occupied; and
if the electromagnetic power is less than the reference value, identifying the slot as not occupied.

4. The method of claim 2, further comprising transmitting the data subcarriers of the slot to be transmitted at a controlled transmission power and transmitting the pilot subcarriers at a fixed power level.

5. The method of claim 4, wherein the measuring comprises measuring electromagnetic power using the pilot subcarriers transmitted at a fixed power level in the slot to be sensed.

6. The method of claim 1, further comprising:
transmitting all the subcarriers of the slot to be transmitted under transmission power control;
generating a carrier sensing slot that a neighboring node uses to sense whether a slot is occupied or not by using designated subcarriers, other than the subcarriers of the slot to be transmitted, and simultaneously transmitting the carrier sensing slot and the slot to be transmitted.

7. The method of claim 6, wherein the transmitting of the carrier sensing slot comprises transmitting the carrier sensing slot at a fixed power level.

8. The method of claim 1, wherein the performing of transmission power control comprises:
setting an initial transmission power for the data subcarriers of the slot for data transmission; and
applying closed-loop transmission power control to the data subcarriers of the slot for data transmission after the setting of the initial transmission power.

9. The method of claim 8, wherein, in the setting of the initial transmission power, the initial transmission power is set using the carrier to interference and noise ratio (CINR) of the slot that is used to reserve the slot for data transmission in the frame.

10. A method for a node to control power in a wireless ad-hoc network using a frame where a plurality of packet data unit (PDU) slots and a plurality of acknowledgment (ACK) slots are multiplexed,
the frame further comprising:
a plurality of PDU sensing slots respectively corresponding to the plurality of PDU slots and used to sense whether channels of the plurality of PDU slots are occupied or not; and
a plurality of ACK slots respectively corresponding to the plurality of ACK slots and used to sense whether channels of the plurality of ACK slots are occupied or not, and
the method comprising:
performing power control on all subcarriers of non-occupied PDU slots or non-occupied ACK slots; and
transmitting all subcarriers of the PDU sensing slots or ACK sensing slots respectively corresponding to the non-occupied PDU slot or ACK slots corresponding to the non-occupied PDU slots or non-occupied ACK slots at a fixed power level.

11. The method of claim 10, further comprising:
sensing whether or not the PDU slots or ACK slots are occupied by other nodes and currently used for transmission.

12. The method of claim 11, wherein the sensing comprises:
measuring electromagnetic power using at least one subcarrier of each PDU sensing slot or each ACK sensing slot; and
determining, from the electromagnetic power, whether or not the PDU slots or ACK slots are occupied.
